(19) United States
(12) Patent Application Publication
(10) Pub. No.: US 2021/0090532 A1
(43) Pub. Date: Mar. 25, 2021

(54) THERMALLY INSULATING CASE FOR MUSICAL INSTRUMENT

(71) Applicant: Greg Campbell, Joliet, IL (US)

(72) Inventor: Greg Campbell, Joliet, IL (US)

(21) Appl. No.: 16/597,129

(22) Filed: Oct. 9, 2019

Related U.S. Application Data
(60) Provisional application No. 62/902,743, filed on Sep. 19, 2019.

(51) Int. Cl. G10G 7/00; B65D 81/38

(52) U.S. Cl. CPC G10G 7/005; B65D 81/389; B65D 81/3893; B65D 81/3897

(57) ABSTRACT

The combination of a portable musical instrument and a thermally insulating case defining a storage space within which at least a majority of a volume of the portable musical instrument resides with the musical instrument in a stored state. The thermally insulating case has a wall with an inside and an outside and that bounds at least a part of the storage space. The wall has at least: a) an inside layer; b) an outside layer; and c) an insulating region between the inside and outside layers. The wall has a flexible shape allowing the wall to be readily reconfigured.

### BACKGROUND OF THE INVENTION

### Field of the Invention

This invention relates to musical instruments and, more particularly, to a thermally insulating case in which a musical instrument can be placed.

### Background Art

Musical instruments, such as guitars, drums, etc., are commonly placed in cases that protect the instruments when they are stored and transported. The objective of designers of these cases is generally two-fold.

First of all, the cases provide a shield against dust and dirt. Secondly, some of the cases are made with rigid walls to reduce the likelihood of damage to the contained instruments when they impact, or are impacted by, other objects.

One problem that has not been adequately addressed by designers of instrument cases is controlling heat transfer between the instruments and the surrounding environment. When environmental conditions are similar as instruments are moved from one location to the next, there may not be any significant issues attributable to temperature change.

However, even when internal and external environmental conditions are similar, direct sun exposure may create problems. For example, musicians commonly transport their instruments from one location to the next as in automobiles where the instruments, either uncovered or in cases, are exposed to strong sunlight. This may produce a rapid heating of the instruments which changes their operating characteristics, in the short term, and in the long term may cause degradation.

At the other extreme, instruments may be exposed to very cold conditions as they are transported to an internal site wherein they will be in a relatively high temperature environment. The same issues are contended with, whether the environmental change is from cold to hot or hot to cold.

Heretofore, the partial solution to the above problems has been to transport the instruments to a location where they will be used far enough in advance that they will reach temperature equilibrium with the end environment in which they will be used. This approach is inconvenient and does not address the issue of the alteration of the condition of the instrument due to drastic and/or repeated temperature changes.

The industry continues to contend with the above problems given the lack of any case design that effectively addresses them.

### SUMMARY OF THE INVENTION

In one form, the invention is directed to the combination of a portable musical instrument and a thermally insulating case defining a storage space within which at least a majority of a volume of the portable musical instrument resides with the musical instrument in a stored state. The thermally insulating case has a wall with an inside and an outside and bounding at least a part of the storage space. The wall has at least: a) an inside layer; b) an outside layer; and c) an insulating region between the inside and outside layers. The wall has a flexible shape allowing the wall to be readily reconfigured.

In one form, the inside layer is made from a waterproof material.

In one form, the outside layer is made from a waterproof material.

In one form, the inside layer has a reflective surface.

In one form, the insulating region is an empty air space.

In one form, the insulating region has an insulating material that is made up of at least one of foam and fiber.

In one form, the inside layer is made from one of: a) plastic; b) vinyl; and c) reflective foil.

In one form, the portable musical instrument is a stringed instrument.

In one form, the portable musical instrument is a drum.

In one form, the thermally insulating case has a main body bounding a cylindrically-shaped portion of the space. The main body has a top, a bottom, and a central axis and is collapsible in an axial direction.

In one form, the main body has a peripheral wall portion and a bottom wall portion that cooperatively define a cup shape to receive the drum.

In one form, the thermally insulating case further includes a lid that is repositionable relative to the main body between open and closed positions. The lid in the open position allows the drum to be selectively directed into and removed from the cylindrically-shaped portion of the space. In the closed position the lid blocks the drum in the cylindrically-shaped portion of the space.

In one form, the lid defines a top portion of the wall.

In one form, the lid is fixedly connected to the peripheral wall portion.

In one form, the peripheral wall portion and top and bottom wall portions cooperatively define a closed cylindrical shape with the lid in the closed position.

In one form, the thermally insulating case has at least one graspable handle to facilitate lifting and transportation of the thermally insulating case.

In one form, at least one of the inside layer and outside layer has a nonwoven fabric construction.

In one form, at least one of the inside and outside layer comprises polyester.

In one form, the outside layer is a woven fabric.

In one form, at least one of the inside and outside layer is a coated fabric layer.

### BRIEF DESCRIPTION OF THE DRAWINGS

FIG. 1 is a schematic representation of one form of the invention, including the combination of a portable musical instrument and a thermally insulating case;

FIG. 2 is a schematic representation showing additional details of a wall on the thermally insulating case in FIG. 1;

FIG. 3 is a perspective view of one exemplary form of portable musical instrument in relationship to one form of thermally insulating case, with the case in a collapsed state,

FIG. 4 is a view as in FIG. 3 wherein the thermally insulating case has been changed to an operative state;

FIG. 5 is a cross-sectional view of a wall on the thermally insulating case taken along the line 5-5 of FIG. 4;

FIG. 6 is a schematic representation of a shape retaining structure on the wall on the thermally insulating case;

FIG. 7 is a schematic representation of an insulating material usable on the wall on the thermally insulating case; and

FIG. 8 is a schematic representation of filler that can be utilized on the wall on the thermally insulating case.

### DETAILED DESCRIPTION OF THE PREFERRED EMBODIMENT

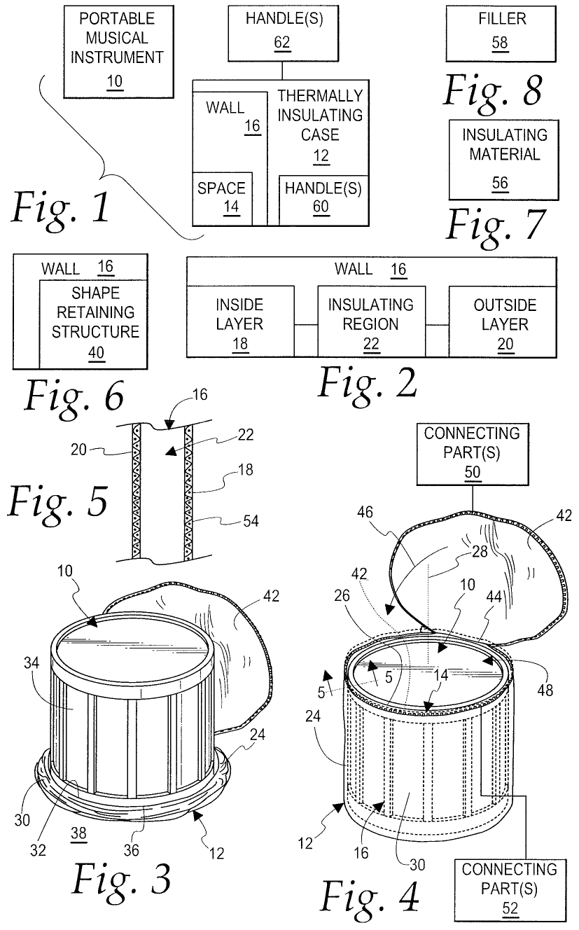

In FIG. 1, one form of the invention is schematically depicted as the combination of a portable musical instrument 10 and a thermally insulating case 12 defining a storage space 14 within which at least a majority of a volume of the portable musical instrument resides with the portable musical instrument in a stored state. The case 12 has a wall 16 with an inside and an outside and that bounds at least a part of the storage space 14.

As seen in FIG. 2, the wall 16 is made up of at least: a) an inside layer 18; b) an outside layer 20; and c) an insulating region 22 between the inside and outside layers 18, 20.

The wall 16 has a flexible shape allowing it to be readily changed in configuration.

The schematic representation of the portable musical instrument 10 is intended to encompass virtually an unlimited number of different forms of portable musical instrument that are commonly transported from one site to the next by a user. As examples, the portable musical instrument 10 might be a drum or a stringed instrument, such as a guitar, violin, banjo, etc. The generic showing in FIG. 1 is intended to encompass an unlimited range of these types of instruments, with tile exemplary form described hereinbelow being representative in nature only.

Likewise, the schematic representation of the thermally insulating case 12, in FIGS. 1 and 2, is intended to encompass the specific forms as hereinbelow described, as well as myriad variations of the components thereof and their interactions.

In FIGS. 3-5, one specific form of the thermally insulating case 12 is shown for storage/containment of a portable musical instrument in the form of a conventional drum 10.

The case 12 depicted has a collapsed state, as shown in FIG. 3, and an operative state, as shown in FIG. 4.

The case 12 has a main body 24 which, with the case 12 in the operative state of FIG. 4, bounds a cylindrically shaped portion 26 of the space 14. In the FIG. 4 state, the main body 24 has a central axis 28.

The main body 24 has a peripheral wall portion 30 and a bottom wall portion 32, that in the FIG. 4 state cooperatively define a cup shape that is nominally matched to the perimeter shape of the contained drum 10 to relatively closely overlie the peripheral wall 34 and underlie the bottom wall 36 of the drum 10.

To facilitate placement of the drum 10 into the space 14, the bottom wall portion 32 can be placed against the supporting surface 38, whereupon the peripheral wall portion 30 can be collapsed downwardly in an axial direction towards the supporting surface 38 to achieve the collapsed state shown in FIG. 3. By then placing the drum 10 against the bottom wall portion 32, the peripheral wall portion 30 can be drawn upwardly to the FIG. 4 state.

The construction of the wall 16 may be such that upon being reconfigured, the peripheral wall portion 30 will maintain each of the states in FIGS. 3 and 4.

Alternatively, as shown in FIG. 6, a shape retaining structure 40 may be incorporated directly into the wall portion 30, or separately therefrom, to maintain the FIG. 4 state. Spring-type mechanisms suitable to perform the function of the shape retaining structure are well known and encompassed within the generic showing of FIG. 6.

The case 12 further includes a lid 42 that may be separate from, or integrally connected to, the peripheral wall portion 30. As depicted, the lid 42 is joined integrally to the peripheral wall portion along a hinge/fold line 44. By pivoting the lid 42 in the direction of the arrow 46 in FIG. 4, the lid 42 can be changed between the depicted open position in FIG. 4 and a closed position, as shown in dotted lines in FIG. 4. In the closed position, the lid 42 blocks a top opening 48 defined by the peripheral wall portion 30.

With the drum 10 received in the space 14 and the lid 42 closed, the drum 10 can be removed by changing the lid 42 from the closed position into the open position and withdrawing the drum 10 through the opening 48.

Alternatively, with the lid changed to its open position, the peripheral wall portion 30 might be collapsed downwardly to gain access to the drum 10.

It is also contemplated that the case might be placed in the FIG. 4 state before introducing the drum 10 into the space 14.

To maintain the lid 42 in its closed position, at least one connecting part 50 is provided on the lid to cooperate with the at least one connecting part 52 on the wall portion 30. The connecting parts 50, 52 may have any known type of releasable construction. For example, the connecting parts 50, 52 may be cooperating zipper components, cooperating hook-and-loop type fasteners, etc. It is preferred, but not required, that the connecting parts 50, 52 effectively cause the lid 42 to fully block the opening 48 to impede heat transfer between the space 14 and the outside environment.

At least the peripheral wall part 30, and more preferably the peripheral wall part 30 and the bottom wall portion 32 and lid 42, have the same construction of the generically depicted wall 16.

As shown in FIG. 5, the wall 16 has the inside layer 18, the outside layer 20, and the insulating region 22, shown generically in FIGS. 1 and 2, between the inside and outside layers 18, 20.

The makeup of the layers 18, 20 and region 22, and their particular arrangement, generally mimics the technology utilized recently on thermally insulating bags and coolers with a flexible wall construction.

In a general sense, at least one of the inside and outside layers 18, 20 is made to limit or block water or other liquid transmission. In one preferred form, one or both of the layers 18, 20 is made from a waterproof material, which may be a plastic or vinyl, or a fabric that might be treated.

In one form, the inside layer 18 has a reflective surface 54.

In one form, the inside layer 54 is made from one of: a) plastic; b) vinyl; and c) a reflective foil.

In one form, at least one of the inside and outside layers 18, 20 has a non-woven fabric construction.

In one alternative form, the outside layer may be made from a woven fabric.

Alternatively, one of the inside and outside layers 18, 20 may be made from polyester.

In a still further alternative form, at least one of the inside and outside layers 18, 20 may be a fabric layer that is coated, as by rubber, to limit water transmission therethrough.

The insulating region 22 may be an empty air space.

More preferably, the insulating region 22 includes an insulating material, shown generally at 56 in FIG. 7, that is made up of at least one of a foam and fiber material.

The region 22 might also incorporate a filler as shown generally at 58 in FIG. 8. The filler may be an insulating material and/or a common gel pack component.

While one exemplary preferred form of the invention has an outer layer 20 made from a heavy fabric, plastic, or vinyl, and an inner layer 18 made from a waterproof material such as plastic, vinyl, foil, etc., the invention contemplates utilizing any and all of the well-known components used in thermally insulating flexible bags, including additional technology and materials as the industry evolves.

Further, the region at 22 is not limited to any specific form and may be a combination of air space and one or more components partially or completely filling the space between the layers 18, 20.

Other materials commonly used in the manufacture of these thermally insulating bags include PET film, Styrofoam, polyethylene, polyurethane, polypropylene, nylon, etc.

The above layers and materials, and others, may be used in different combinations. Additional layers may be utilized beyond those depicted, with the number of such layers being potentially well in excess of the three depicted in the drawings.

As shown in FIG. 1, the case 12 may incorporate at least one handle 60 that is graspable to facilitating lifting and transportation of the case 12.

Alternatively, one or more graspable handles 62 may be separately attached to facilitate lifting and transportation of the case 12.

The foregoing disclosure of specific embodiments is intended to be illustrative of the broad concepts comprehended by the invention.

1. In combination:
a portable musical instrument; and
a thermally insulating case defining a storage space within which at least a majority of a volume of the portable musical instrument resides with the musical instrument in a stored state,
wherein the thermally insulating case comprises a wall having an inside and an outside and bounding at least a part of the storage space,
wherein the wall comprises at least: a) an inside layer; b) an outside layer; and c) an insulating region between the inside and outside layers,
the wall having a flexible shape allowing the wall to be readily reconfigured.

2. The combination according to claim 1 wherein the inside layer is made from a waterproof material.

3. The combination according to claim 1 wherein the outside layer is made from a waterproof material.

4. The combination according to claim 1 wherein the inside layer has a reflective surface.

5. The combination according to claim 1 wherein the insulating region comprises an empty air space.

6. The combination according to claim 1 wherein the insulating region comprises an insulating material that is made up of at least one of foam and fiber.

7. The combination according to claim 1 wherein the inside layer is made from one of: a) plastic; b) vinyl; and c) reflective foil.

8. The combination according to claim 1 wherein the portable musical instrument is a stringed instrument.

9. The combination according to claim 1 wherein the portable musical instrument is a drum.

10. The combination according to claim 9 wherein the thermally insulating case comprises a main body bounding a cylindrically-shaped portion of the space, the main body having a top, a bottom, and a central axis and collapsible in an axial direction.

11. The combination according to claim 10 wherein the main body has a peripheral wall portion and a bottom wall portion that cooperatively define a cup shape to receive the drum.

12. The combination according to claim 11 wherein the thermally insulating case further comprises a lid that is repositionable relative to the main body between open and closed positions, the lid in the open position allowing the drum to be selectively directed into and removed from the cylindrically-shaped portion of the space and in the closed position blocking the drum in the cylindrically-shaped portion of the space.

13. The combination according to claim 12 wherein the lid defines a top portion of the wall.

14. The combination according to claim 12 wherein the lid is fixedly connected to the peripheral wall portion.

15. The combination according to claim 13 wherein the peripheral wall portion and top and bottom wall portions cooperatively define a closed cylindrical shape with the lid in the closed position.

16. The combination according to claim 1 wherein the thermally insulating case has at least one graspable handle to facilitate lifting and transportation of the thermally insulating case.

17. The combination according to claim 1 wherein at least one of the inside layer and outside layer has a nonwoven fabric construction.

18. The combination according to claim 1 wherein at least one of the inside and outside layer comprises polyester.

19. The combination according to claim 1 wherein the outside layer comprises a woven fabric.

20. The combination according to claim 1 wherein at least one of the inside and outside layer is a coated fabric layer.
